(19) United States
(12) Patent Application Publication
(10) Pub. No.: US 2012/0030487 A1
(43) Pub. Date: Feb. 2, 2012

(54) INFORMATION PROCESSING APPARATUS AND POWER CONTROL METHOD

(75) Inventor: Masaki TAKINAMI, Ome-shi (JP)

(73) Assignee: KABUSHIKI KAISHA TOSHIBA, Tokyo (JP)

(21) Appl. No.: 13/195,456

(22) Filed: Aug. 1, 2011

(30) Foreign Application Priority Data
Jul. 30, 2010 (JP) 2010-172737

(51) Int. Cl. G06F 1/26; G06F 1/32

(52) U.S. Cl. 713/320; 713/300

(57) ABSTRACT

According to one embodiment, an information processing apparatus includes a first circuit, a second circuit, and a controller. The first circuit is configured to detect consumed power of the information processing apparatus. The second circuit is configured to supply power received from a battery or an external power supply device, to a component in the information processing apparatus. The controller is configured to control the second circuit to receive the power from both of the battery and the external power supply device when the consumed power detected by the first circuit is higher than a capacity of the external power supply device.

### CROSS REFERENCE TO RELATED APPLICATION(S)

This application is based upon and claims the benefit of priority from Japanese Patent Application No. 2010-172737 filed on Jul. 30, 2010, the entire contents of which are incorporated herein by reference.

### FIELD

Embodiments described herein relate generally to an information processing apparatus such as a battery-operable personal computer and a power control method applied to the information processing apparatus.

### BACKGROUND

In recent years, various kinds of notebook-type or laptop-type portable personal computers have been developed. Many of such personal computers are driven by receiving power supply from an AC adapter or a secondary battery.

AC adapters provided in related-art portable personal computers are set at a rated power not less than the maximum power of the system. Recent portable personal computers are frequently placed under high load because of image processing and the like, and consume an increasing amount of power. Therefore, the rated power of AC adapters tends to be high.

On the other hand, with the size reduction of portable personal computers in recent years, the AC adapters provided in the portable personal computers are also required to be reduced in size.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is an exemplary perspective view showing an appearance of an information processing apparatus according to an embodiment

FIG. 2 is an exemplary block diagram showing a system configuration of the information processing apparatus;

FIG. 3 is an exemplary circuit view showing a structure of a power supply system in the information processing apparatus;

FIG. 4 is a view for explaining the power supply from an AC adapter and a battery of the information processing apparatus; and

FIG. 5 is an exemplary flow chart showing the power control procedure of the information processing apparatus

### DETAILED DESCRIPTION

In general, according to one embodiment, an information processing apparatus includes a first circuit, a second circuit, and a controller. The first circuit is configured to detect consumed power of the information processing apparatus. The second circuit is configured to supply power received from a battery or an external power supply device, to a component in the information processing apparatus. The controller is configured to control the second circuit to receive the power from both of the battery and the external power supply device when the consumed power detected by the first circuit is higher than a capacity of the external power supply device.

An exemplary embodiment will be described with reference to the drawings.

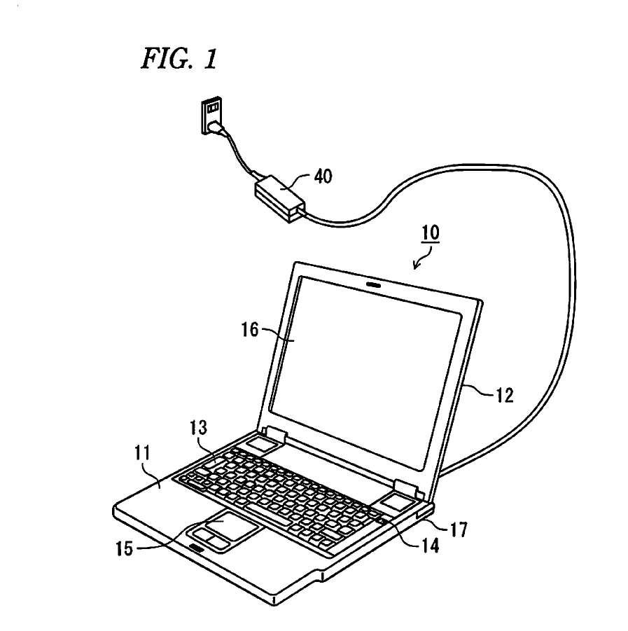

First, referring to FIG. 1, the structure of an information processing apparatus according to an embodiment will be described. This information processing apparatus is implemented, for example, as a battery-operable notebook-type portable personal computer 10. FIG. 1 is a perspective view of the computer 10 with the display unit being opened, viewed from the front side.

The computer 10 includes a computer main body 11 and a display unit 12. The display unit 12 incorporates a display device constructed of an LCD (liquid crystal display) 16.

The display unit 12 is supported by the computer main body 11, and attached to the computer main body 11 so as to be pivotable between an opened position where the top surface of the computer main body 11 is exposed and a closed position where the top surface of the computer main body 11 is covered by the display unit 12. The computer main body 11 has a thin box-form housing, and on the top surface thereof, a keyboard 13, a power switch 14 for powering on and off the computer 10, and a touch pad 15 are disposed.

A battery 17 is, for example, removably fitted in a rear end portion of the computer main body 11. The battery 17 may be, for example, a lithium-ion battery (high capacity battery) intended for higher capacity.

The computer main body 11 is provided with a power connector 20 (not shown in FIG. 1). The power connector 20 is provided on the back surface of the computer main body 11. An external power supply device is detachably connected to the power connector 20. As the external power supply device, an AC adapter 40 can be used. The AC adapter 40 is a power supply device that converts commercial power (AC power) to DC power. In other words, the AC adapter 40 is a device that supplies external direct current to the computer 10.

The power connector 20 is constructed of a jack to which a power plug drawn from the external power supply device such as the AC adapter 40 is detachably connectable.

The computer 10 is driven by the power from the AC adapter 40 or the power from the battery 17. The power from the external power supply device can be used also for charging the battery 17. The battery 17 may be charged not only while the power of the computer 10 is on but also while the power of the computer 10 is off. While the AC adapter 40 is not connected to the power connector 20 of the computer 10, the computer 10 is driven by the power from the battery 17.

The system maximum load power (consumed power) of the computer 10 is provided by the power from the AC adapter 40 and the power from the battery 17. The system maximum load power of the computer 10 is the sum total of the consumed power when the components in the computer 10 operate at the highest throughput.

Normally, as the external power supply device provided in an information processing apparatus, a device of a rated power that corresponds to the maximum load of the system of the information processing apparatus is provided. That is, setting is made so that the maximum load power of the system can be provided only by the power supplied from the external power supply device.

However, in the computer 10, power can be simultaneously supplied from both the AC adapter 40 and the battery 17. Therefore, it is unnecessary that the AC adapter 40 correspond to the system maximum load power of the computer 10. Consequently, the AC adapter 40 can be replaced with an adapter of a rated power lower than normal.

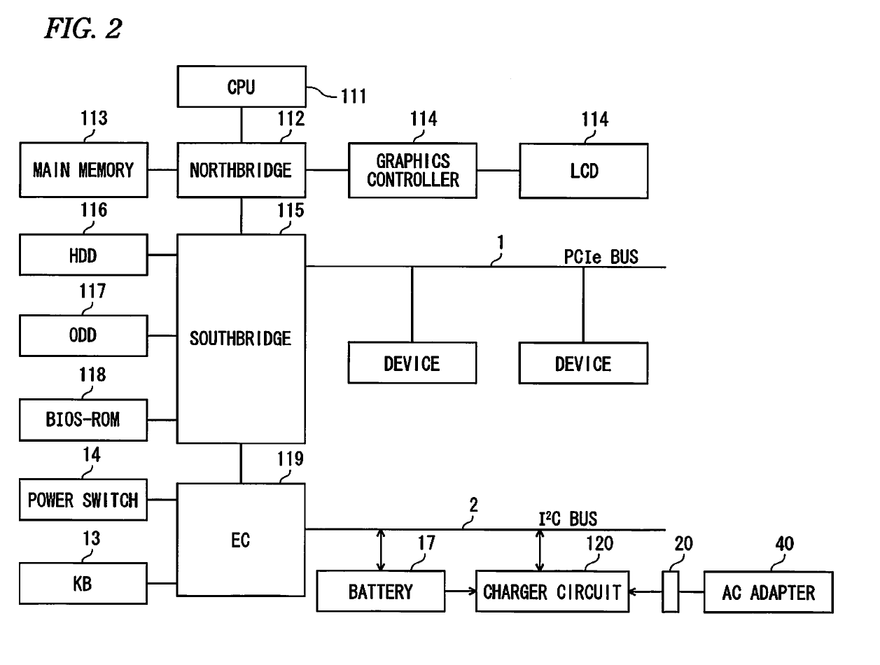

FIG. 2 shows the system configuration of the computer 10. The computer 10 includes a CPU 111, a northbridge 112, a main memory 113, a graphics controller 114, a southbridge 115, a hard disk drive (HDD) 116, an optical disk drive (ODD) 117, a BIOS-ROM 118, an embedded controller (EC) 119, a charger circuit 120 and the AC adapter 40.

The CPU 111 is a processor that controls the operations of the components of the computer 10. The CPU 111 executes various pieces of software, for example, the operating system (OS) and various application programs loaded from the HDD 116 to the main memory 113. The CPU 111 also executes the BIOS (basic input output system) stored in the BIOS-ROM 118 which is a nonvolatile memory. The BIOS is a system program for hardware control.

The northbridge 112 is a bridge device that connects between the local bus of the CPU 111 and the southbridge 115. The northbridge 112 also has the function of executing communication with the graphics controller 114. Further, the northbridge 112 incorporates a memory controller that controls the main memory 113. The graphics controller 114 is a display controller that controls the LCD 16 used as the display monitor of the computer 10.

The southbridge 115 is connected to a PCIe bus 1, and executes communication with devices on the PCIe bus 1. The southbridge 115 incorporates an IDE (integrated drive electronics) controller and a serial ATA controller for controlling the HDD 16 and the ODD 17.

The EC 119 and the battery 17 are interconnected through a serial bus (I²C bus 2). The EC 119 is a power management controller for managing the power of the computer 10, and implemented, for example, as a one-chip microcomputer incorporating a keyboard controller that controls the keyboard (KB) 13, the touch pad 15 and the like. The EC 119 has the function of powering on and off the computer 10 in response to an operation of the power switch 14 by the user. The control of the power-on and power-off of the computer 10 is executed by the EC 119. When an ON signal is received, the EC 119 controls the charger circuit 120 to power on the computer 10. When an OFF signal is received, the EC 119 controls the charger circuit 120 to power off the computer 10. The EC 119 and the charger circuit 120 also operate by the power from the battery 17 or the AC adapter 40 while the power of the computer 10 is off.

The charger circuit 120 generates power (operating power supply) to be supplied to the components, by using the power from the battery 17 attached to the computer main body 11 or the power from the AC adapter 40 connected to the computer main body 11 as the external power source. When the AC adapter 40 is connected to the computer main body 11, the charger circuit 120 generates the operating power supply to the components by using the power from the AC adapter 40, and can charge the battery 17.

In the present embodiment, for example, the output voltage of the AC adapter 40 is higher than that of the battery 17. In this case, the AC adapter 40 is preferentially used as the power source.

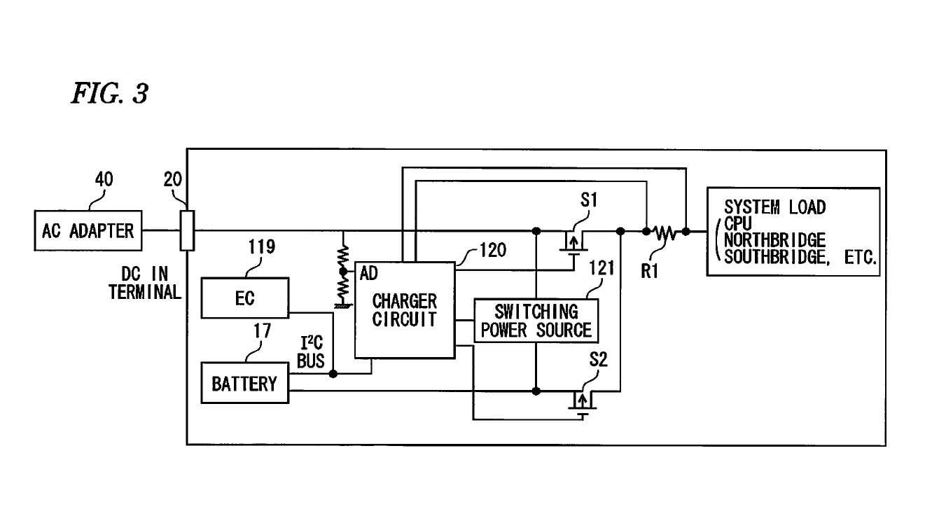

Next, referring to FIG. 3, an example of the structure of the power supply system in the computer 10 will be described. The power supply system of FIG. 3 includes switches S1 and S2, a resistor R1, the battery 17, the EC 119, the charger circuit 120 and a switching power source 121.

The EC 119 connects with the battery 17 through the I²C bus 2. The EC 119 communicates with the microcomputer in the battery 17 via the I²C bus 2, and receives information representative of the detection and charging condition of the battery 17 or the like.

The EC 119 also controls the charger circuit 120. The EC 119 determines whether the AC adapter 40 is connected or not through the AD port of the charger circuit 120. That is, when a voltage not less than a certain value is detected at the AD port, the EC 119 determines that the AC adapter 40 is connected.

The charger circuit 120 controls the switches S1 and S2 and the switching power source 121 under the control of the EC 119. The charger circuit 120 also detects the current outputted to the system load based on the voltage across the resistor R1.

The EC 119 detects the load power of the system based on the current value detected by the charger circuit 120. The EC 119 classifies the load power of the system into three conditions (conditions A, B and C), and controls the charger circuit 120 according to each condition.

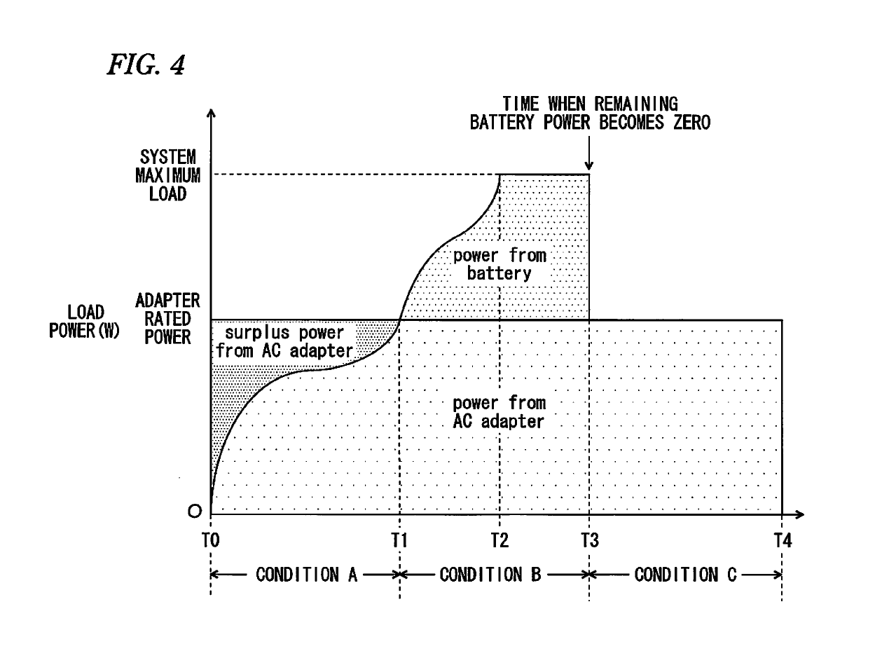

Next, the operations of the components in the three conditions will be described by using FIG. 4. FIG. 4 is a view for explaining the power supply from the AC adapter 40 and the battery 17 of the computer 10. As shown in FIG. 4, from T0 to T3, the load power of the system increases with the lapse of time. From T3, the system load power is held at the adapter rated capacity.

The condition A is a condition in which the system load power is not more than the rated power of the AC adapter 40. In the condition A, the charger circuit 120 turns on the switch S1 and turns off the switch S2. That is, the system load is provided by the power from the AC adapter 40. The charger circuit 120 also calculates the surplus power by subtracting the system load power value from the value of the power from the AC adapter 40. The charger circuit 120 charges the battery 17 by the surplus power. The charger circuit 120 performs conversion from the AC voltage to the battery voltage by using the switching power source 121, and charges the battery 17.

The condition B is a condition in which the system load power is higher than the rated power of the AC adapter 40 and there is power left in the battery 17. The charging information of the battery 17 is obtained by the EC 119 through the I²C bus 2. In the condition B, the charger circuit 120 turns off the switch S1 and turns on the switch S2. In the circuit in the condition B, the system load power is supplied by the power from the AC adapter 40 and the battery 17. From times T1 to T2, the system load power increases, and reaches the maximum load power of the system at the time T2. After the maximum load capacity of the system is reached, the maximum load of the system is handled by the power from the AC adapter 40 and the power form the battery 17. Therefore, the AC adapter 40 can be reduced in size compared with when the maximum load of the system is handled only by the AC adapter 40.

The condition C is a condition in which the system load capacity is reduced forcibly and maintained at the rated capacity of the AC adapter 40. That is, it is a condition in which no power is left in the battery 17 although the system load capacity is higher than the rated capacity of the AC adapter 40. The EC 119 accesses the battery 17 through the I²C bus 2, and detects that the remaining power of the battery 17 is zero. Then, the EC 119 controls the charger circuit 120 to turn on the switch S1 and turn off the switch S2. In the circuit in the condition C, the system load power is supplied by the power from the AC adapter 40.

The EC 119 also transmits an SMI (system management interrupt) signal to the CPU 111. The SMI signal transmitted to the CPU 111 is processed by the BIOS. For example, this SMI signal provides an instruction to switch the computer 10 to the power saving mode. An example of the power saving mode is a slot ring. The slot ring is to reduce the operating frequency of the CPU 111 or the like or to intermittently operate the CPU 111 or the like.

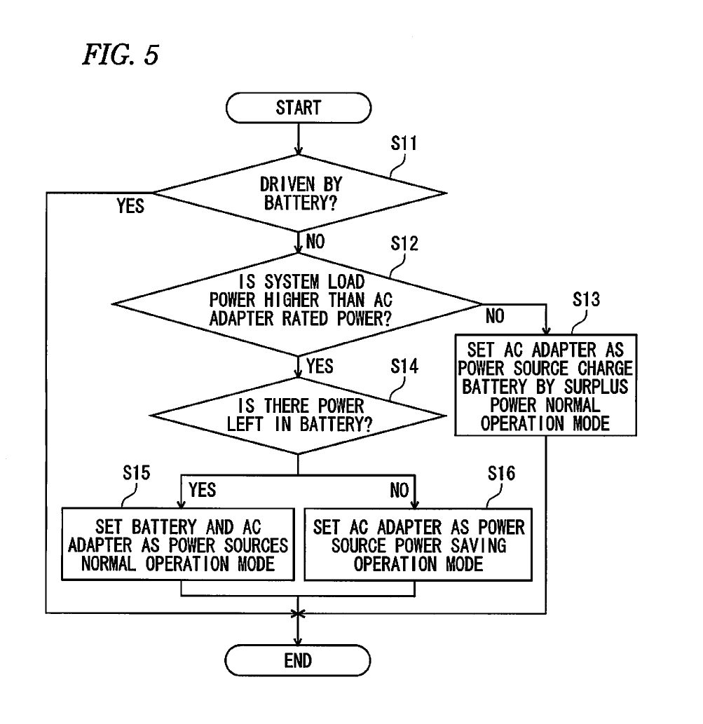

Next, the method of power control performed by the EC 119 will be described by using FIG. 5. First, the EC 119 determines whether the computer 10 is driven by the battery 17 or not (step S11).

When determining that the computer 10 is driven by the battery 17 as a result of the determination at step S11 (Yes of step S11), the EC 119 ends the power control procedure. When determining that the computer 10 is not driven by the battery 17 as a result of the determination at step S11 (No of step S11), the EC 119 determines whether the system load power is higher than the rated power of the AC adapter 40 or not (step S12).

When determining that the system load power is not more than the rated power of the AC adapter 40 as a result of the determination at step S12 (No of step S12), the EC 119 charges the battery 17 by the surplus power with the AC adapter 40 as the power source (step S13). The operation mode of the computer 10 is kept the normal operation mode.

On the other hand, when the system load power is higher than the rated power of the AC adapter 40 as a result of the determination at step S12 (Yes of step S12), the EC 119 determines whether there is power left in the battery 17 or not (step S14). When determining that there is power left in the battery 17 as a result of the determination at step S14 (Yes of step S14), the EC 119 sets the AC adapter 40 and the battery 17 as the power sources (step S15). When determining that there is no power left in the battery 17 as a result of the determination at step S14 (No of step S14), the EC 119 sets the AC adapter 40 as the power source, and sets the operation mode of the computer 10 to the power saving mode (step S16).

As mentioned above, in the present embodiment, power can be simultaneously supplied from both the AC adapter 40 and the battery 17. Therefore, the AC adapter 40 can be set at a rated power lower than the system load power of the computer 10. That is, size reduction of the AC adapter 40 can be realized.

Moreover, when the system load power of the computer 10 is not more than the rated power of the AC adapter 40, the battery 17 can be charged by using the surplus power. With this structure, when the system load is low, the driving time when the computer 10 is driven by the battery 17 can be prolonged by charging the battery 17 while driving the computer 10, so that convenience improves.

Moreover, when the system load power of the computer 10 is higher than the rated power of the AC adapter 40 and there is no power left in the battery 17, the computer 10 is set in the power saving mode. An example of the power saving mode is to reduce the operating frequency of the CPU 111, the graphics controller 114 or the like or to intermittently operate the CPU 111, the graphics controller 114 or the like. With this structure, size reduction of the AC adapter 40 is realized while user operability is hardly affected.

While certain embodiments have been described, these embodiments have been presented by way of example only, and are not intended to limit the scope of the invention. Indeed, the novel apparatus and method described herein may be embodied in a variety of other forms; furthermore, various omissions, substitutions and changes in the form of the apparatus and method, described herein may be made without departing from the sprit of the invention. The accompanying claims and their equivalents are intended to cover such forms or modifications as would fall within the scope and sprit of the invention.

What is claimed is:

1. An information processing apparatus comprising:
a power-detection circuit configured to detect consumed power of the information processing apparatus;
a power-supply circuit configured to supply power received from a battery or an external power supply to a component in the information processing apparatus; and
a controller configured to allow the power-supply circuit to receive the power from both the battery and the external power supply device when the consumed power detected by the power-detection circuit is higher than a capacity of the external power supply device.

2. The apparatus of claim 1, wherein when the consumed power is lower than the capacity of the external power supply device, the controller is configured to allow the power-supply circuit to charge the battery by the power received from the external power supply.

3. The apparatus of claim 1, wherein when the consumed power is higher than the capacity of the external power supply device and power left in the battery is less than or equal to a minimum amount, the controller is configured to reduce power consumption by the component in the information processing apparatus.

4. A method of controlling power in an information processing apparatus, comprising:
detecting an amount of power consumed by the information processing apparatus;
comparing the detected consumed power and a capacity of an external power supply device; and
receiving power from both the battery and the external power supply device when the consumed power is higher than the capacity of the external power supply device.

5. The method of claim 4 further comprising:
charging the battery by the power received from the external power supply device when the consumed power is lower than the capacity of the external power supply device.

6. The method of claim 4 further comprising:
reducing power consumption by a component in the information processing apparatus when the consumed power is higher than the capacity of the external power supply device and power left in the battery is less than or equal to a minimum amount.
